(19) United States
(12) Patent Application Publication
(10) Pub. No.: US 2008/0117106 A1
(43) Pub. Date: May 22, 2008

(54) Emitter Geolocation

(75) Inventors: Giuseppe Carlos Sarno, Essex (GB); Ray Larsen, Essex (GB)

Correspondence Address: CROWELL & MORING LLP;INTELLECTUAL PROPERTY GROUP, P.O. BOX 14300, WASHINGTON, DC, 20044-4300, US

(73) Assignee: BAE Systems plc, London (GB)

(21) Appl. No.: 10/565,972

(22) PCT Filed: Dec. 1, 2005
(86) PCT No.: PCT/GB05/50223

§ 371 Date: Jan. 26, 2006

(30) Foreign Application Priority Data
Dec. 3, 2004 (GB) 0426815.7

(51) Int. Cl. G01S 5/06

(52) U.S. Cl. 342/444

(57) ABSTRACT

A method and means for correcting for refraction effects of the earth's atmosphere in an emitter geolocation technique for locating an emitter of electromagnetic waves by means of a plurality of receivers, including detecting the times of arrival of electromagnetic waves at the receivers, computing the relative time differences of arrival between the various receivers and estimating therefrom the position of the emitter, and for correcting, by means of an iterative procedure, the detected times of arrival for path length discrepancies caused by refraction in the earth's atmosphere. The receivers are each mounted on a respective airborne platform, and at least three pairs of said receivers are provided.

### FIELD OF THE INVENTION

The present invention relates to a method and means of locating the position of an emitter of electromagnetic waves by means of a plurality of receivers.

### BACKGROUND OF THE INVENTION

Systems are well known for computing position information of a ground based emitter from a number of airborne platforms. Techniques, known as emitter geolocation, or multiple platform emitter geolocation, incorporate a variety of radar, GPS and communications technologies. One such technique involves computing time difference time of arrival (TDOA) of a signal from an emitter arriving at a number of receptors. A review of location techniques is presented in “Microwave Emitter Position Location: Present and Future”, Paradowski, pages 97-116, 12th International Conference on Microwaves and Radar, 1998. MIKON '98, Volume: 4, 20-22 May 1998.

Corrections in radar systems for bending of the line of propagation due to refraction in the earth's atmosphere are necessary so that correct range to an emitter can be deduced. Detailed algorithms are described in L. V. Blake, Lexington Books, “Radar Range-Performance Analysis”.

### SUMMARY OF THE INVENTION

The invention provides apparatus for locating an emitter of electromagnetic waves by means of a plurality of receivers, each receiver including means for detecting the time of arrival of said electromagnetic waves at said receiver, and means for computing the relative time differences of arrival between said receivers and for estimating therefrom the position of the emitter, and including means for correcting said detected times of arrival for path length discrepancies caused by the earth's atmosphere.

In a further aspect, the invention provides a method for locating an emitter of electromagnetic waves by means of a plurality of receivers, comprising detecting the times of arrival of said electromagnetic waves at said receivers, computing the relative time differences of arrival between said receivers and estimating therefrom the position of the emitter, and correcting said detected times of arrival for path length discrepancies caused by the earth's atmosphere.

In at least a preferred embodiment, the invention includes an algorithm that applies a correction for the effect of atmospheric propagation on the time-of-arrival (TOA) of an RF signal emanating from a ground-based emitter and received at a number of airborne platforms. Variation in the refractive profile of the atmosphere causes RF signals to “bend” and to deviate from a straight line path. The actual path taken by the signal is thus longer than the direct path. This affects the estimate of the duration of the flight of the signal. A traditional method of location of emitters is TDOA which uses the difference in time-of-flight observed by pairs of receiving platforms. Path bending, as described above, will affect these measurements and, hence, affect the location of the emitter. Without correction of path bending the estimate of the emitter location will be significantly in error.

The algorithm is an iterative scheme that provides a refined estimate of the emitter location. This is done by forming an initial estimate of the emitter location using the TDOA technique and the uncorrected TOA measurements. A ray tracing integral is then used with this initial emitter location estimate to estimate the true path (to each receiving platform). This results in refined TOA measurements, thus refined TDOA estimates and thus a refined emitter location estimate. The procedure is continued until the differences between successive TDOA corrections are sufficiently small.

The invention improves the estimation of the location of an emitter when airborne receiving platforms are used to locate ground-based emitters, particularly when the receiving platforms are a great distance away from the emitter. It has proved, surprisingly, that very few iterations are required before convergence to an acceptable solution is obtained. Further, the invention has been shown to work with non-standard atmospheres, including specialised atmospheric refractive profiles. The invention may work with any arbitrary atmospheric refractive profile, even if not defined fully by mathematical equations.

The invention has been proved in the context of location of a ground-based RF emitter by airborne platforms. The invention works, with little modification, in the opposite sense, i.e. the location of an airborne emitter by ground-based (or airborne) receiving platforms.

The invention is applicable to path length variations in the context of locating emitters subject to different atmospheric effects, provided the atmospheric effect can be represented as a function of geometric parameters such as range and height.

Having regard to the foregoing, thus, it is to be appreciated that the invention also resides in a computer program comprising program code means which when loaded into a computer will enable it to operate in the apparatus described hereinabove. Further, the invention also resides in a computer program comprising program code means for performing the method steps described hereinabove when the program is run on a computer. Furthermore, the invention also resides in a computer program product comprising program code means stored on a computer readable medium for performing the method steps described hereinabove when the program is run on a computer.

### BRIEF DESCRIPTION OF THE DRAWINGS

A preferred embodiment of the invention will now be described with reference to the accompanying drawings wherein:

FIG. 1 is a schematic illustration of a preferred embodiment of the invention, showing the effect of atmospheric refraction on signal propagation path between a ground emitter and an airborne receiving platform;

FIG. 2 is a flow diagram of a TDOA correction estimation algorithm incorporated in the preferred embodiment;

FIG. 3 is a geometric figure used in the algorithm of FIG. 2;

FIG. 4 is a block diagram of a modification of the first embodiment employing a Kalman filter;

FIG. 5 is a plot of actual emitter location estimate before/after refraction correction in an example;

FIG. 6 is a histogram showing the number of iterations required to achieve convergence in the algorithm of FIG. 2;

FIG. 7 is a plot showing location solution without Kalman Filter correction; and

FIG. 8 is a plot showing location solution with Kalman Filter correction.

### DESCRIPTION OF THE PREFERRED EMBODIMENT

In a location system that uses time-difference of arrival (TDOA) measurements for geo-locating an emitter it has previously been assumed that the ray path from the emitter to each measuring platform is a straight line. With no refraction this assumption is true. However, electromagnetic waves always refract (bend) for various reasons. The refractive index of the atmosphere varies with air pressure, temperature and water content and is a function of altitude. Ducts, such as evaporation ducts over the sea surface, will also cause ray bending.

A common refractive profile (refractivity versus height) in radar is to assume an atmosphere that has a constant gradient with height. This gives rise to the “4/3 model” where the earth radius is multiplied by 4/3 to obtain an Earth where EM rays become straight lines. This model is satisfactory for low altitudes; beyond about 5 to 8 km the model is unrepresentative. There are a number of different profiles in existence, including those particular to specific regions. For envisaged large slant ranges to the emitter (>300 km) the ray-bending effect becomes important. Without correction, it is reasonable to assume that the emitter location would be estimated wrongly (as shown below, principally in altitude). In accordance with the invention, an iterative algorithm is provided that provides an estimate of corrections to apply to TDOA measurements to convert them to measurements that represent the straight-line path (non-refractive) from the emitter to each ELS (Emitter Location System) platform. A Kalman filter, for refinement of emitter location estimation, may be provided.

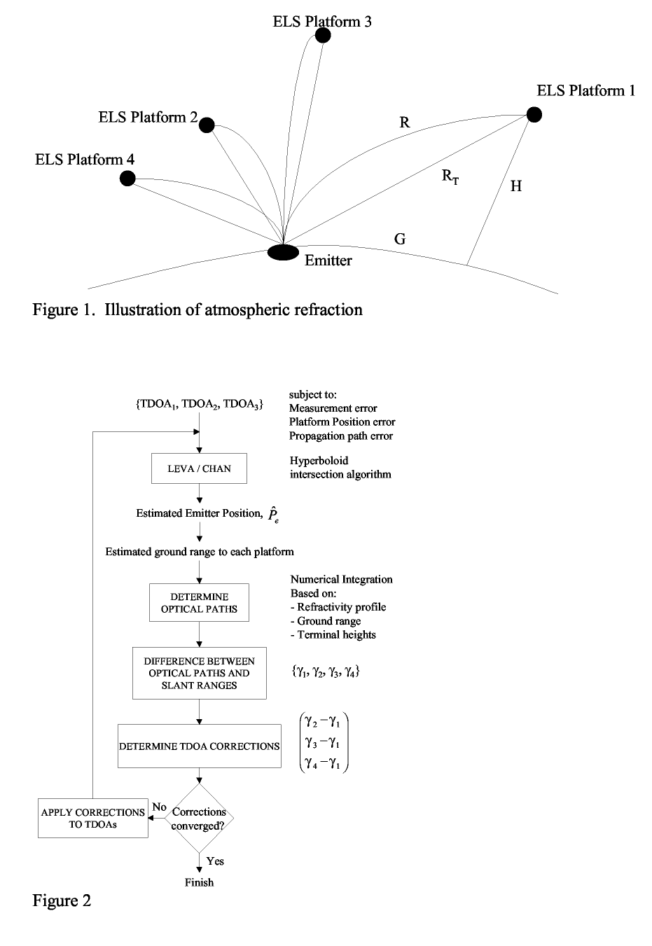

The problem due to refraction through the atmosphere of an emitter's transmissions on emitter geo-location is illustrated schematically in FIG. 1. Four ELS, 1, 2, 3 and 4 are shown, providing three pairs of measurement platforms. Emission from an Emitter undergoes refraction and will be seen at an ELS platform with a larger time-of-arrival (TOA), R, than expected from a straight-line path (R_{T}). The resultant TDOA from a pair of platforms will be different than the TDOA obtained by assuming straight-line paths R, because the path bending to each platform will be different. Each ELS includes a Radar antenna A, a receiver Rx, controller C, and transceiver T. The TDOA obtained from a pair of ELS platforms characterises a hyperboloid in space, whose surface represents a region of possible emitter location, to derive the same TDOA value (with measurement error there is uncertainty in the true emitter position). The hyperboloids based on the actual TDOA values will be different in shape to those representing the straight-line TDOAs, and hence the intersection of the hyperboloids (in this case, three, from three pairs of ELS platforms), representing the emitter location, will be in error too.

The receiving platforms observe signals from an emitter with a time-of-flight related to range R. However, these platforms, when attempting to locate the emitter, have previously assumed that the path is denoted by R_{T}. The emitter is assumed to be further away than it is. The TDOA technique actually obtains differences in the bent paths R for the various receiving platforms used and thus obtains incorrect TDOA measurements. In accordance with the invention, the following equation denotes the TDOA obtained from platform i and j (strictly speaking this equation defines a Range-Difference of arrival rather than Time-Difference, but this is unimportant to the algorithm):

TDOA_{i,j}=ƒ(\hat{X}ⱼ,Ŷⱼ,\hat{Z}ⱼ,xₑ,yₑ,zₑ,)−ƒ(\hat{X}ᵢ,Ŷᵢ,\hat{Z}ᵢ,xₑ,yₑ,zₑ,)+γⱼ−γᵢ

where f is a non-linear function which gives slant range (or equivalently, straight-line time of flight) from emitter at (xₑ, yₑ, zₑ) to platform at (X, Y, Z). The platform positions are labelled (\hat{X},Ŷ,\hat{Z}) to emphasise that platform positions are not exactly known and thus contribute to TDOA measurement error. γᵢ is the additional path due to path bending (in range or time) for platform i compared to a straight line path.

The invention minimises γⱼ−γᵢ,the residual path length due to differences in path bending to platforms i and j. The algorithm is described by the flow diagram shown in FIG. 2. The steps are as follows:
1. Measure TDOA between pairs of platforms (minimum of 3 pairs required for 3D location of emitter).
2. Assuming straight-line paths, use an algorithm, e.g. Leva “An alternative closed-form solution to the GPS pseudorange equations” Mitre Journal 1997, pages 39 to 54, to obtain a 3D estimate of emitter position

Then, for each receiving platform:
3. Using this initial emitter estimate, obtain the ground range G from emitter to a receiving platform.
4. Use the ground range, (known) receiving platform height, and assumed refractive profile in a ray-tracing integral equation (See L. V. Blake, “Radar Range-Performance Analysis”, Lexington Books) to predict the bent path length:

$$R = {\int }_{{h}_{0}}^{{h}_{1}} \frac{n ( h )}{\sqrt{1 - [ \frac{{n}_{0} cos ( {θ}_{0} )}{n ( h ) [ 1 + \frac{h}{re} ]} ]}} \cdot d h$$

where
n (h) describes the atmospheric refractive profile as a function of height
n₀ is the refractive index at the earth surface
θ₀ is the take-off angle of the ray at the emitter
h₀ and h₁ are the start and end heights of the path
re is the earth radius

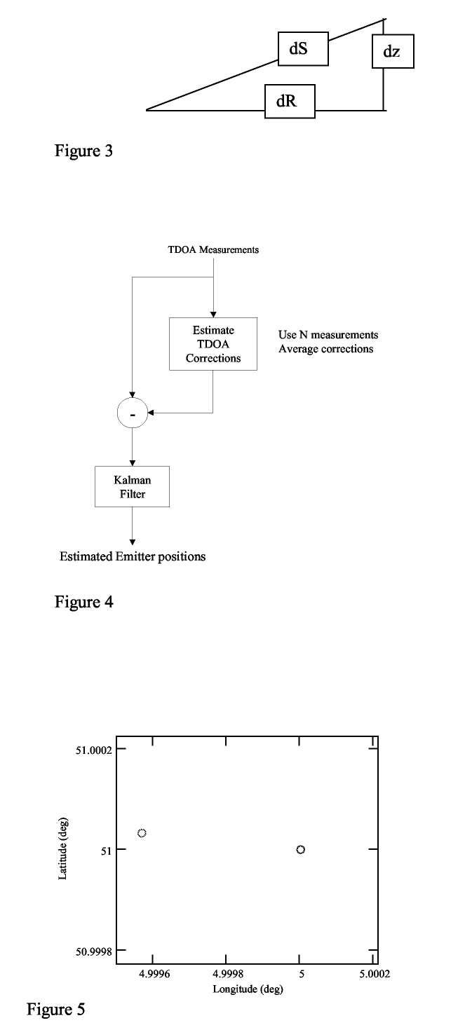

The integral is recast, for the purposes of this algorithm, so that the integral is in terms of ground range rather than height. A problem in using the above is that the take-off angle for each refracted path is not known. This is the reason why an initial estimate of emitter location is required, since this will provide an estimate of range between emitter and platform (e.g. ground range). By resetting the above integral into a different form one may integrate in terms of ground range; then the path calculation takes the form of a simple root-finding problem where one attempts to find a take-off angle which provides a path with the correct final height, h₁, at the correct ground range G. The algorithm for numerically integrating this “alternative” ray-tracing integral is as follows (see the right angled triangle of FIG. 3):

dS=C*dR+|(m²−C²)^{1/2}*dz(1+z/a)|

dz/dR=(1+z/a)*(m²−C²)^{1/2}/C

or dz=(1+z/a)*(m²−C²)^{1/2}*dR/C

where
C=(1+z0/a)*n0*cos(θ₀) (i.e. a constant)
z0 is starting height
a is radius of earth
n0 is starting refractive index (i.e. 1.000300, or thereabouts)
θ₀ is starting elevation angle (angle above horizontal)
m=(1+z/a)*n (m is known as the modified refractive index)
5. Obtain the difference between the estimated bent path length and the straight-line path (obtained from the estimated emitter position). This forms a correction to the TDOA measurement in Step 1. Then go to Step 2.
6. Continue until the corrections in Step 5 converge.

A Kalman filter, as shown in FIG. 4, may additionally be employed for filtering the emitter location estimates. Since the Kalman filter is used with more than one measurement the correction scheme is applied to several TDOA measurements separately and the corrections (from Step 6 above) are averaged.

Thus, the difference between the refracted path length, R, and the slant range R_{T} for a particular platform forms a correction to the TDOA measurements. The adjusted TDOA measurements are then used to provide a “refined” estimate of emitter position and, hence, “refined” estimates of ground ranges and “refined” estimate of TDOA correction. It is expected that there is a point at which the corrections do not change significantly. There may be situations where this may occur but a factor which precludes this is the highly similar paths of the ELS platforms (platforms are close together with respect to their distance to the emitter), since, then, the path residuals mentioned above will be relatively small, giving rise to reasonable initial estimate of emitter position.

### Illustrations

The invention has been tested by simulation for a number of different cases, but with the basic scenario consisting of an emitter located over 300 km from 4 closely-spaced airborne receiving platforms at a nominal 10 km altitude. Various refractive profiles were assumed, including the standard ITU exponential model and one representative of Dakar—this being a particularly “bad” case for ray bending. The behaviour of the algorithm is the presence and absence of other measurement errors was performed as well as its interaction with a further stage of emitter estimate refinement (Kalman filtering).

FIG. 5 shows the effect of correction on the estimation of the emitter position in the presence of atmospheric refraction via the standard ITU exponential model (and no other measurement errors). In this case the emitter location was estimated perfectly. Without correction the emitter was located approximately 28 m from its true position.

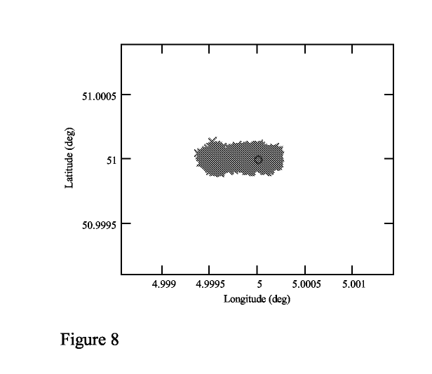

Another test observed the output of the Kalman filter refinement stage as shown in FIG. 4. FIGS. 7 and 8 show the output of the Kalman filter in its steady-state (i.e. when its output had converged), where the TOA measurements have been subjected to path bending, described by a model for Dakar, firstly without correction then with correction via the proposed scheme. Quantitatively, the improvement obtained over a number of statistical runs is shown in the following table:

TABLE
Mean and standard deviation of EKF location
solution error (to two decimal places)

| | Latitude (m) | | Longitude (m) | | Altitude (m) | |
|---|---|---|---|---|---|---|
| | Mean | S.D. | Mean | S.D. | Mean | S.D. |
| Correction | 0.51 | 048 | −2.59 | 8.06 | −17.71 | 14.77 |
| No | −3.92 | 0.49 | 32.29 | 8.11 | 1576.08 | 14.9 |
| correction | | | | | | |

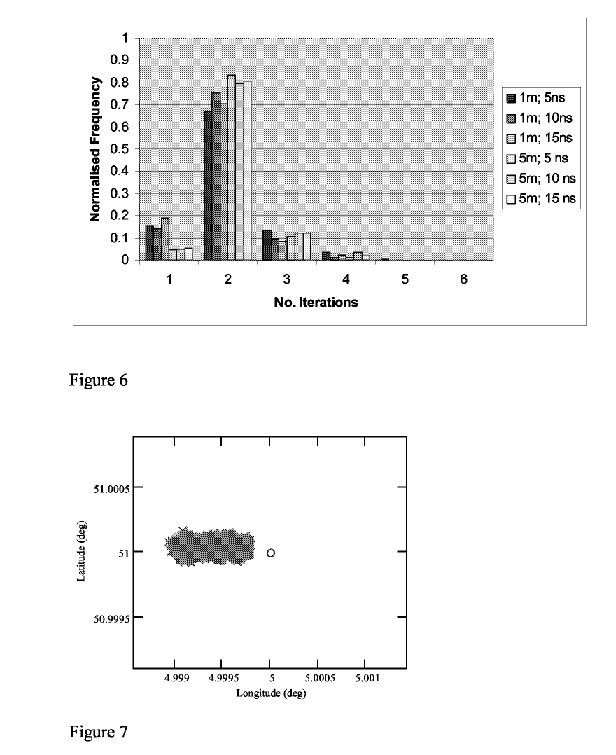

A statistical approach was used for analysing solution convergence of the algorithm of FIG. 2. 200 sets of TDOA measurements (each set consists of three TDOA values obtained from the four ELS platforms were synthesised with random measurement errors. Each measurement was processed as above, and the number of iterations required to achieve convergence recorded. The results are shown in FIG. 6.

Observations of the results showed that there was little difference in convergence for the different platform pairs, hence the results from all three pairs were conglomerated to form a histogram. Therefore 600 iteration values were analysed. These cases cover two different levels of platform position error: 1 m and 5 m, and three levels of TOA error: 5 ns, 10 ns and 15 ns. These values represent one Standard Deviation. These values were chosen to examine how the level of measurement error affects the estimation of TDOA correction.

As shown, two to four iterations are sufficient to “ensure” convergence to a solution. In the case of oscillatory behaviour an even number of solutions should be averaged to derive a final solution.

Accuracy of the converged TDOA correction estimates was investigated by calculating a TDOA correction estimate for each of a number of measurements (200 sets of TDOA values, each subjected to random platform position and TOA errors), comparing these estimates with the true corrections then obtaining the mean and standard deviation of the errors. Although measurement errors were present (see above) the results show that sub-metre accuracy is obtainable, with a spread of similar magnitude. Slightly greater error spread was observed with larger measurement errors, but only marginally so.

These results indicate that measurement error should not significantly affect the accuracy of the TDOA correction scheme, when the refractive profile is known.

Having thus described the present invention by reference to a preferred embodiment, it is to be appreciated that the embodiment is in all respects exemplary and that modifications and variations are possible without departure from the spirit and scope of the invention. For example, whilst in the embodiment the invention has been described in the context of location of a ground-based emitter by airborne platforms, the invention could alternatively work with little modification in the opposite sense i.e. in context of location of an airborne emitter by ground-based (or airborne) receiving platforms. Furthermore, it is to be appreciated that the invention may work with any arbitrary atmospheric refractive profile, if desired, for example even if not defined fully by mathematical equations.

1. Apparatus for locating an emitter of electromagnetic waves by means of a plurality of receivers, each receiver including means for detecting the time of arrival of said electromagnetic waves at said receiver, and means for computing the relative time differences of arrival between said receivers and for estimating therefrom the position of the emitter, and including means for correcting said detected times of arrival for path length discrepancies caused by the earth's atmosphere.

2. Apparatus according to claim 1, wherein the discrepancies are caused by refraction.

3. Apparatus according to claim 1, wherein each said receiver is mounted on a respective airborne platform, and at least three pairs of said receivers are provided.

4. Apparatus according to claim 3, wherein said correcting means is arranged to carry out the following steps:
a) measure time differences of arrival between pairs of said receivers;
b) assuming straight-line paths, obtain an estimate of emitter position;
c) for each receiver: using said estimate, obtain the ground range from emitter to a receiving platform;
d) using said ground range, and known height, and assumed refractive profile in a selected ray-tracing integral equation to predict actual path length;
e) obtain the difference between said predicted path length and the straight-line path obtained from the estimated emitter position to form a correction to said time differences of arrival in Step a);
f) return to Step b);
g) Continue until the corrections in Step e) converge.

5. Apparatus according to claim 1, wherein, said correcting means is arranged to perform the following ray tracing equation
$$. R = {\int }_{{h}_{0}}^{{h}_{1}} \frac{n ( h )}{\sqrt{1 - [ \frac{{n}_{0} cos ( {θ}_{0} )}{{n ( h ) [ 1 + \frac{h}{re} ]}^{2}} ]}} \cdot d h ,$$
where R is the path length, n (h) describes the atmospheric refractive profile as a function of height, n₀ is the refractive index at the earth surface, θ₀ is the take-off angle of the ray at the emitter, h₀ and h₁ are the start and end heights of the path, re is the earth radius.

6. Apparatus according to any claim 5, including a Kalman filter for improving said correction.

7. A method for locating an emitter of electromagnetic waves by means of a plurality of receivers, comprising detecting the times of arrival of said electromagnetic waves at said receivers, computing the relative time differences of arrival between said receivers and estimating therefrom the position of the emitter, and correcting said detected times of arrival for path length discrepancies caused by the earth's atmosphere.

8. A method according to claim 7, wherein the discrepancies are caused by refraction.

9. A method according to claim 7, wherein said receivers are each mounted on a respective airborne platform, and at least three pairs of said receivers are provided.

10. A method according to claim 9, wherein said correcting is carried out by the following steps:
a) measure time differences of arrival between pairs of said receivers;
b) assuming straight-line paths, obtain an estimate of emitter position;
c) for each receiver: using said estimate, obtain the ground range from emitter to a receiving platform;
d) using said ground range, and known height, and assumed refractive profile in a selected ray-tracing integral equation to predict actual path length;
e) obtain the difference between said predicted path length and the straight-line path obtained from the estimated emitter position to form a correction to said time differences of arrival in Step a)
f) return to Step b)
g) continue until the corrections in Step e) converge.

11. A method according to claim 7, wherein said correcting performs the following ray tracing equation
$$R = {\int }_{{h}_{0}}^{{h}_{1}} \frac{n ( h )}{\sqrt{1 - [ \frac{{n}_{0} cos ( {θ}_{0} )}{{n ( h ) [ 1 + \frac{h}{re} ]}^{2}} ]}} \cdot d h ,$$
where R is the path length, n (h) describes the atmospheric refractive profile as a function of height, n₀ is the refractive index at the earth surface, θ₀ is the take-off angle of the ray at the emitter, h₀ and h₁ are the start and end heights of the path, re is the earth radius.

12. A method according to claim 7, including providing a Kalman filter for improving said correction.

13. A computer program comprising program code means for performing the method steps of claim 7 when the program is run on a computer.

14. A computer program product comprising program code means stored on a computer readable medium for performing the method steps of claim 7 when the program is run on a computer.

15. A computer program which when loaded into a computer will enable it to operate in the apparatus of claim 1.

16. (canceled)

17. (canceled)
